(19) United States
(12) Patent Application Publication
(10) Pub. No.: US 2020/0002459 A1
(43) Pub. Date: Jan. 2, 2020

(54) LIGHTWEIGHT TILE

(71) Applicant: Far Eastern New Century Corporation, Taipei (TW)

(72) Inventors: Chao-Yi CHANG, Taoyuan City (TW); Chun-Chieh CHIEN, Taoyuan City (TW); Ya-Ying CHANG, Taoyuan City (TW); Yueh-Chu WANG, Taoyuan City (TW)

(21) Appl. No.: 16/427,365

(22) Filed: May 31, 2019

(30) Foreign Application Priority Data
Jun. 29, 2018 (TW) 107122666

(51) Int. Cl. C08G 18/42; C08G 18/08; C08G 18/76; C08G 18/75; C08K 7/14; B05D 7/26

(52) U.S. Cl. CPC C08G 18/4211; C08G 18/14; C08G 18/4238; C08G 18/7664; C08G 2101/0025; C08G 18/755; C08K 7/14; B05D 7/26; C08G 18/7621

(57) ABSTRACT

The present disclosure provides a lightweight tile. The lightweight tile has a tile body and a lacquer layer overlaying on the tile body. The tile body is composed of a rigid foamed resin having a plurality of void cells. The density of the rigid foamed resin is 0.2 to 0.45 g/cm³. The lightweight tile provided in the present disclosure is less dense than the conventional ceramic tiles. In addition, the heat insulation and sound insulation of the lightweight tile are excellent.

### CROSS-REFERENCE TO RELATED APPLICATION

This application claims priority to Taiwan Application Serial Number 107122666, filed Jun. 29, 2018, which is herein incorporated by reference.

### BACKGROUND

### Field of Invention

The present disclosure relates to a tile which is usually called a porcelain tile. More particularly, this invention relates to a lightweight tile suitable for wall surface pavement.

### Description of Related Art

In the architecture field, tiles are commonly used on buildings' inner and outer walls, floors, or other surfaces that need to be decorated, such as kitchen countertops. Conventional tiles are high-temperature fired products which are made of ceramic clay, feldspar, terracotta, quartz, etc. Tiles having a glaze covered thereon are called glazed tiles, while tiles without a glaze covered thereon are called unglazed tiles. Tiles are also known as porcelain tiles.

Conventional tiles can be classified into three types—ceramic tiles, stone tiles, and porcelain tiles—based on the tiles material. In general, ceramic tiles and stone tiles are classified as glazed tiles, while porcelain tiles are homogenous tiles having a low water absorption rate and a high hardness.

When tiles are used for wall decoration and building materials protection, especially for indoor walls, the fundamental goals include color chroma, pattern variety, texture, and overall arrangement of tiles, while there are less particular requirement on tile hardness and tile mechanical strength. Therefore, ceramic tiles are often used because they are inexpensive.

However, when tiles are paved on the wall surface of the outer wall, the tiles may fall off because of careless construction, inferior tile quality or long-term impact of thermal expansion and contraction, just to name a few. Because conventional tiles are made of ceramic clay, feldspar, terracotta, quartz and the like, in which their density is greater than 2 g/cm³, and therefore the tile body made thereof is heavy. Once tiles fall off the wall surface, especially in the case the tiles falling off in a large area and considering the gravity acceleration, it is very likely to cause damages to human and property. Therefore, human injuries or property loss caused by tiles falling from the outer wall of aged buildings are often in the news. In addition, the weight of tiles goes up along with the size of tiles. Heavy tiles may hinder the construction works of the outer surface of a high-rise building and meanwhile increase the risk of tiles falling off from the wall surface.

In addition, as mentioned above, conventional tiles are made of clay, stone, and the like. These materials are similar to the materials of concrete walls, and therefore the thermal conductivity and sound insulation effect of tiles and concretes are similar. However, the thermal insulation and sound insulation effect of conventional concrete wall surface are not perfect. In order to attain a higher thermal insulation and sound insulation effect, the thickness of the wall has to be increased. However, this may result in a huge rise in construction cost and bring more burdens to the construction works, and the building may be overweight. In order to address these issues arise from wall thickening, a person skilled in the art may coat a heat insulation layer on the wall surface or set up a thermal insulation board above the wall surface to enhance the thermal insulation performance of the concrete wall. In addition, a person skilled in the art may set up a sound insulation board above the wall surface to enhance the sound insulation performance of the concrete wall. However, this may destroy the aesthetic of the wall surface and lead to a lot of construction works, and the construction cost is increased.

Accordingly, a lightweight tile is needed in the field of building material, especially a lightweight tile having additional functions such as thermal insulation and sound insulation.

### SUMMARY

One purpose of the present disclosure is to provide a lightweight tile to reduce problems in the construction works and damages caused by falling tiles.

In order to achieve the purpose, the present disclosure provides a lightweight tile that includes a tile body and a lacquer layer overlaying on at least one surface of the tile body. The tile body is composed of a rigid foamed resin that includes a plurality of void cells.

In one and more embodiments, the density of the tile body is preferably ranged from 0.25 g/cm³ to 0.4 g/cm³.

In one and more embodiments, the void cells consist of a plurality of open cells and a plurality of closed cells. The percentage of the number of open cells in the total number of open cells and closed cells (which is termed as “open cell content” hereinafter) is ranged from 5% to 20%.

In one and more embodiments, at least one protruding portion is disposed on a bottom surface or a side of the lightweight tile of the present disclosure, such that the adhesion of the lightweight tile of the present disclosure to the cement is increased and the risk of the tile falling from the wall surface is reduced.

The lightweight tile of the present disclosure has a lower density than the conventional tile and therefore meets the lightweight requirement. The lightweight tile of the present disclosure can be readily manufactured into a large area and cut to the desired size, such that the manufacturing cost can decrease effectively. The lightweight tile of the present disclosure can also be prepared in various shapes or cut into various shapes and sizes as required. The tile of the present disclosure may have different appearances depending on the color and type of the lacquer layer paved on the tile body.

Moreover, the tile body in the present disclosure is composed of a rigid foamed resin, which can further impart better thermal and acoustic insulation effects to the lightweight tile.

### BRIEF DESCRIPTION OF THE DRAWINGS

FIG. 1 is a schematic sectional view of a portion of a lightweight tile according to one embodiment of the present disclosure.

FIG. 2 is a schematic sectional view of a portion of a lightweight tile according to another embodiment of the present disclosure.

### DETAILED DESCRIPTION

The present disclosure is further described with accompanying diagrams. Those skilled in the arts can readily understand the present disclosure after reading the disclosure of this specification. It is understood that the following description is merely for illustration and do not intend to limit the present disclosure.

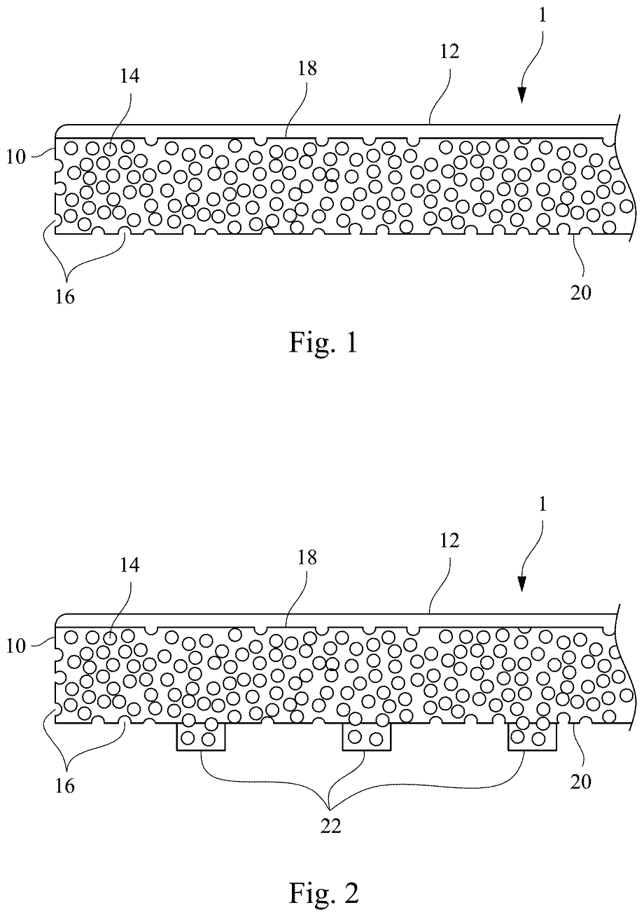

Reference is made to FIG. 1. FIG. 1 is a schematic sectional view of a portion of a lightweight tile according to one embodiment of the present disclosure. A lightweight tile 1 of the present disclosure primarily includes a tile body 10 and a lacquer layer 12. The lacquer layer 12 overlays a surface of the tile body 10, and the surface includes at least an upper surface 18.

The tile body 10 is composed of a rigid foamed resin that includes a plurality of void cells. The void cells are air-filled, and thus the density of the tile body 10 is lower, such that the weight of the present disclosure lightweight tile 1 may decrease effectively. In one or more embodiments, the density of tile body 10 preferably ranges from 0.2 g/cm³ to 0.45 g/cm³, more preferably from 0.25 g/cm³ to 0.4 g/cm³. A lower density results in a more lightweight tile, but the overall mechanical strength may decrease. On the other hand, a higher density results in a heavier tile weight, such that the tile is not sufficiently lightweight, and the thermal insulation and sound insulation effect of the tile are affected as well.

In one or more embodiments, the void cells consist of a plurality of closed cells 14 and a plurality of open cells 16.

In one or more embodiments, the open cell content in the void cells of the tile body 10 preferably ranges from 5% to 20%, more preferably from 10% to 15%. If the open cell content is too high, the thermal insulation effect will decrease. On the other hand, if the open cell content is too low, the desired sound absorption will not be attained. In addition, the presence of the open cells 16 may cause an uneven surface of the tile body 10, which may improve the adhesion to the lacquer layer 12 and the adhesion to the cement during a subsequent plastering process, such that the lightweight tile 1 of the present disclosure is less likely to fall off from the wall surface.

In one or more embodiments, the tile body 10 is composed of a rigid foamed resin. The rigid foamed resin may be obtained by foaming an isocyanate compound with a polyol by adding a foaming agent and a catalyst. The types and quantities of the isocyanate compound, polyol, foaming agent and catalyst in the present disclosure are not limited as long as they may achieve the properties as defined above. Those skilled in the art may select the suitable material types and tailor the appropriate composition ratio to form the rigid foamed resin having the properties as required through the description of the present disclosure.

In one or more embodiments, the isocyanate compound which may be used in the present disclosure includes di-isocyanate. The di-isocyanate includes toluene-2,4-diisocyanate (TDI), isophorone diisocyanate (IPDI), 4,4′-diphenylmethane diisocyanate (MDI), dicyclohexylmethane-4,4′-diisocyanate, (HMDI), lysine diisocyanate (LDI), and polyisocyanate (PolyMDI), but is not limited thereto. In one or more embodiments, polyisocyanate (PolyMDI) is preferable.

In one or more embodiments, the polyol which may be used in the present disclosure includes aromatic polyester polyol, aliphatic polyester polyol, and polyether polyol, but is not limited thereto. In one or more embodiments, an aromatic polyester polyol is preferable.

In one or more embodiments, in order to enhance the mechanical strength of the tile body 10, glass fiber may be added to the raw material of the rigid foamed resin during the preparation process thereof, such that the glass fiber is embedded in the rigid foamed resin. Alternatively, other additives, for example, nanoparticles, that can reinforce the rigid foamed resin may be added to the raw material of the rigid foamed resin, such that the rigid foamed resin is similar to a nanoparticle reinforced composite, but it is not limited thereto.

The lacquer layer 12 overlays on at least one surface of the tile body 10. Any paint that can be coated on the rigid foamed resin is suitable to be used in the present disclosure, and there is no particular limitation in the present disclosure. Those skilled in the art may select the paint as desired based on the desired color, appearance, properties of the lacquer, and the like. For example, in order to make the appearance of the lightweight tile 1 of the present disclosure is similar to that of a conventional tile, a Stone flake paint, which is also called stone textured paint, may be coated on the lightweight tile 1, but is not limited thereto. In addition, in order to further enhance the flame resistance of the tile in the present disclosure, any known fire retardant paint may be selected to be the lacquer layer 12 in the present disclosure, which is paved on the surface of the tile body 10.

In one or more embodiments, besides overlaying on the upper surface 18 of the tile body 10, the lacquer layer 12 may further overlay on the bottom surface 20 or the side surface.

In the present disclosure, the method of paving the lacquer layer 12 on the tile body 10 may adopt any known process of forming a lacquer layer, which is made of paint, on the tile body 10 without any particular limitation. For example, a coating process, a spray-coating process, a dip-coating process, or a vapor deposition process, but is not limited thereto.

Reference is made to FIG. 2. FIG. 2 is a schematic sectional view of a portion of a lightweight tile according to another embodiment of the present disclosure. In order to enhance the adhesion between the lightweight tile 1 of the present disclosure and the cement and reducing the chance of falling tile, a protruding portion 22 may be further disposed on the tile body 10. In one or more embodiments, the protruding portion 22 may be disposed on the side surface of the tile body 10 in addition to disposed on the bottom surface 20. There is no particular limitation for the size, shape, and the position of the protruding portion 22 in the present disclosure as long as they may increase the contact area between the tile body 10 and the cement or forming a physical embedded structure. The protruding portion 22 may have a sectional shape, such as a round shape, an oval shape, a triangular shape, a square shape, a polygon shape, a star shape, an H shape, and the like, but is not limited thereto.

In one or more embodiments, the protruding portion 22 is formed integrally with the tile body 10. For example, by using a mold design, the rigid foamed resin is molded during the foaming and manufacturing of the lightweight tile of the present disclosure. In one or more embodiments, the protruding portion 22 may be prepared individually and attached to the tile body 10 subsequently by any known bonding method. For example, using an adhesive to attach the protruding portion 22 and the tile body 10.

The density of conventional tile is about 2.5 g/cm³. However, the density of the lightweight tile in the present disclosure is 0.2 g/cm³ to 0.45 g/cm³. Therefore, under the same volume, the weight of the lightweight tile of the present disclosure is less than ⅕ of the weight of the conventional tile, and the weight drops by more than 80%. In addition, the body of the lightweight tile of the present disclosure is a rigid foamed resin having numerous void cells therein. Therefore, the mechanical strength, thermal insulation, and sound insulation of the lightweight tile of the present disclosure are higher than that of a resin board of the same weight.

### EXAMPLES

Preparation of Tile Body

### Example 1

An aromatic polyester polyol was prepared from 8.38 g of bis(2-hydroxyethyl) terephthalate (BHET) (purchased from Oriental Union Chemical Corporation, OUCC), 2.01 g of diethylene glycol (DEG) (purchased from Oriental Union Chemical Corporation, OUCC), and 3.69 g of phthalic anhydride (PA) (purchased from Union Chemical Industry Co., Ltd.).

In accordance with the quantities as shown in Table 1, the aromatic polyester polyol, a polyisocyanate (Model PU-807A, purchased from Harry Materials Association), a catalyst (Model 33LV, purchased from DABCO), water (foaming agent) and a foam stabilizer (Model L-6900, purchased from Momentive) were weighted individually. These ingredients except polyisocyanate were put in a container and mixed (in a rotation speed of about 1,000 rpm) by using a stirrer (Xinnuo Instrument Equipment Co., Ltd., Model JB90-S) to form a first mixture. The first mixture was then stirred in a rotation speed of about 2,500 rpm, and the weighted polyisocyanate was added simultaneously. Stop stirring after the mixing was complete (about 10 seconds) to form a second mixture.

The second mixture was immediately placed in a sealed mold (having a mold size of 10×10×1 centimeter). The mold was then placed in an oven (50° C., 10 minutes) for foaming. Next, a foam was taken out after the mold was cooled down. In this way, a rigid foam having a density of 0.25 g/cm³ was obtained, and this was the tile body of the present disclosure.

The upper surface of the tile body was coated with a layer of Stone flake paint (Taiwan Guobao Refining Paint Ink Co., Ltd., Model JS-906). The tile body was then dried in an oven at 60° C. for three hours and thereby obtaining the lightweight tile of the present disclosure.

TABLE 1

| | Example | Example | Example | Example | Example |
|---|---|---|---|---|---|
| Ingredients (g) | 1 | 2 | 3 | 4 | 5 |
| polyester polyol | 11.51 | 18.42 | 11.51 | 11.51 | 11.51 |
| polyisocyanate | 13.13 | 21.01 | 13.13 | 13.13 | 13.13 |
| catalyst | 0.12 | 0.19 | 0.12 | 0.12 | 0.12 |
| foaming agent | 0.12 | 0.19 | 0.12 | 0.12 | 0.12 |
| foam stabilizer | 0.12 | 0.19 | 0.12 | 0.12 | 0.12 |

### Example 2

The experimental procedures and conditions of Example 2 and Example 1 were the same, and the difference is that the quantity of each ingredient in Example 2 was increased to 1.6-fold of those in Example 1. A rigid foam with a density of 0.4 g/cm³ was obtained.

### Example 3

The experimental procedures and conditions of Example 3 and Example 1 were the same, and the difference is that the polyester polyol in Example 1 was replaced by an aromatic polyester polyol (Model PS-2502A) of Stepanpol Company. A rigid foam with a density of 0.25 g/cm³ was obtained.

### Example 4

The experimental procedures and conditions of Example 4 and Example 1 were the same, and the difference is that the polyester polyol in Example 1 was replaced by an aliphatic polyester polyol (purchased from Terrin Company, Model Terrin 168). A rigid foam with a density of 0.25 g/cm³ was obtained.

### Example 5

The experimental procedures and conditions of Example 5 and Example 1 were the same, and the difference is that the polyester polyol in Example 1 was replaced by a polyether polyol (purchased from Dow Company, Model Voranol 360). A rigid foam with a density of 0.25 g/cm³ was obtained.

Measurement of the Open Cell Content

The open cell content of the tile bodies obtained in Examples 1 to 5 were measured by using a true density analyzer (TITANEX, Model Quanchrome 1200e) in accordance with the instrument user manual. The open cell content of the tile bodies are listed in Table 2.

TABLE 2

| | Example | Example | Example | Example | Example |
|---|---|---|---|---|---|
| Item | 1 | 2 | 3 | 4 | 5 |
| density | 0.25 | 0.4 | 0.25 | 0.25 | 0.25 |
| (g/cm³) | | | | | |
| open-cell | 15 | 10 | 13 | 13 | 14 |
| content (%) | | | | | |

Mechanical Strength Test

The mechanical strength of the tile bodies obtained in Examples 1 to 5 were tested individually by using a universal material testing machine (YOTEC, Model UT-300) in accordance with Method CNS 4396 of Chinese National Standards. The mechanical strength of the tile bodies obtained in Examples 1 to 5 is 332 N/cm², 422 N/cm², 305 N/cm², 298 N/cm², and 294 N/cm² respectively, as listed in Table 3.

### Comparative Example 1

The mechanical strength of a commercial tile (Champion Building Materials CO., LTD, Model TS6701R, having a size of 10 cm×10 cm×0.5 cm) was tested in accordance with the aforementioned testing method. The mechanical strength of the commercial tile is 266 N/cm², as listed in Table 3.

### Comparative Example 2

The mechanical strength of a commercial polyethylene terephthalate (PET) board (purchased from STIMEX, Model A-PET, in a size of 10×10×0.2 centimeter) was tested in accordance with the aforementioned testing method. The mechanical strength of the commercial PET board is 34.45 N/cm², as listed in Table 3.

TABLE 3

| | Example | Example | Example | Example | Example | Comparative | Comparative |
|---|---|---|---|---|---|---|---|
| Item | 1 | 2 | 3 | 4 | 5 | Example 1 | Example 2 |
| mechanical | 332 | 422 | 305 | 298 | 294 | 266 | 34.45 |
| strength | | | | | | | |

As shown in the measurement results in Table 3, compared with the PET board of the same weight, the lightweight tile of the present disclosure has an apparently higher mechanical strength, which is about 10-fold higher. In addition, as shown in the results, the weight of the lightweight tile of the present disclosure decreases drastically, but the mechanical strength of the lightweight tile of the present disclosure is still higher than the mechanical strength of the conventional tile.

Thermal Insulation Test

By using a thermal conductivity analyzer (Hot Disk, Sweden, Model TPS 2500), the thermal conductivities of the tile bodies obtained in Examples 1 to 5 and Comparative Examples 1 to 2 were measured in accordance with the testing method ISO 22007-2. The thermal conductivity of the tile bodies obtained in Examples 1 to 5 is respectively 0.05 W/m·K, 0.1 W/m·K, 0.07 W/m·K, 0.06 W/m·K, and 0.08 W/m·K (W: heat; m: thickness of the material (meter); K: Kelvin temperature (absolute temperature)). The results are listed in Table 4.

TABLE 4

| | Example | Example | Example | Example | Example | Comparative | Comparative |
|---|---|---|---|---|---|---|---|
| Item | 1 | 2 | 3 | 4 | 5 | Example 1 | Example 2 |
| thermal | 0.05 | 0.1 | 0.07 | 0.06 | 0.08 | 1.8 | 0.2 |
| conductivity | | | | | | | |

From the results as shown in Table 4, the lightweight tile of the present disclosure has a thermal conductivity lower than the conventional tile, and their difference is more than 18-fold. That is, under the same thickness and duration, compared with the conventional tile, the lightweight tile of the present disclosure may drastically reduce more than 94% of the heat transfer. In other words, by paving the lightweight tile of the present disclosure on the outer wall of the building, the external heat transfer to the indoor building through the wall in unit time can decrease drastically, and thereby reducing the energy consumption of the indoor air conditioning equipment, saving energy, and reducing carbon emission.

Even compared with a PET board, the thermal conductivity of the conventional PET is still higher than that of the lightweight tile of the present disclosure by more than 2-fold. That is, under the same thickness, the heat transferring through the conventional PET board is higher than that through the lightweight tile of the present disclosure by more than 2.5-fold. However, in this case, the weight of the conventional PET board is heavier than that of the lightweight tile of the present disclosure by more than 5-fold (the density of PET is about 1.38 g/cm³).

Sound Insulation Test

In general, the sound insulation of a partition is evaluated by the loss of a 500 Hz sound transmitting through the partition. If the loss of the 500 Hz sound transmitting through the partition is 40 dB, then the sound insulation board is classified as STC 40. A larger number after STC (Sound Transmission Class) represents a higher sound blocking performance of a structural body.

The tile bodies obtained in Examples 1 to 5 were subjected to a sound insulation test for measuring the STC of the tile body in accordance with ASTM E413 Classification for Rating Sound Insulation. The STC of the tile bodies obtained in Examples 1 to 5 is 71 dB, 48 dB, 63 dB, 62 dB, and 68 dB respectively, as listed in Table 5.

On the other hand, the sound insulation effect of the commercial tile of Comparative Example 1 and the PET board of Comparative Example 2 were measured individually in accordance with the abovementioned sound insulation testing method. The STC of the commercial tile of Comparative Example 1 and the PET board of Comparative Example 2 is 25 dB and 26 dB respectively, and the results are listed in Table 5.

TABLE 5

| | Example | Example | Example | Example | Example | Comparative | Comparative |
|---|---|---|---|---|---|---|---|
| Item | 1 | 2 | 3 | 4 | 5 | Example 1 | Example 2 |
| STC sound | 71 | 48 | 63 | 62 | 68 | 25 | 26 |
| insulation | | | | | | | |
| performance | | | | | | | |

From the results as shown in Table 5, the lightweight tile of the present disclosure has a better sound insulation effect compared with the conventional tile and PET board. Therefore, if the conventional tile that is paved on the outer wall of buildings is replaced by the lightweight tile of the present disclosure, the external sound transmitting to the indoor building through the wall may decrease. In this way, it is not necessary to increase the thickness of the building wall to enhance the sound insulation effect and thereby reducing the construction cost and the building weight.

Although the present disclosure has been described in considerable detail with reference to certain embodiments thereof, the spirit and scope of the appended claims should not be limited to the description of the embodiments contained herein. It is intended that the present disclosure cover modifications and variations of this invention provided they fall within the scope of the following claims.

What is claimed is:

1. A lightweight tile, comprising:
a tile body composed of a rigid foamed resin, wherein the tile body comprises a plurality of void cells; and
a lacquer layer overlaying at least one surface of the tile body, wherein the tile body has a density ranged from 0.2 g/cm³ to 0.45 g/cm³.

2. The lightweight tile of claim 1, wherein the density of the tile body ranges from 0.25 g/cm³ to 0.4 g/cm³.

3. The lightweight tile of claim 1, wherein the void cells in the tile body has an open cell content ranged from 5% to 20%.

4. The lightweight tile of claim 3, wherein the open cell content of the void cells in the tile body ranges from 10% to 15%.

5. The lightweight tile of claim 1, wherein the rigid foamed resin is obtained by foaming a mixture of an isocyanate compound and a polyol by adding a foaming agent and a catalyst into the mixture.

6. The lightweight tile of claim 5, wherein the isocyanate compound is a polyisocyanate.

7. The lightweight tile of claim 5, wherein the polyol is an aromatic polyester polyol.

8. The lightweight tile of claim 5, wherein the polyol is an aliphatic polyester polyol.

9. The lightweight tile of claim 1, wherein the rigid foamed resin further comprises a glass fiber in the rigid foamed resin.

10. The lightweight tile of claim 1, further comprising a protruding portion disposed on the tile body.
